(19) United States
(12) Patent Application Publication
(10) Pub. No.: US 2022/0294716 A1
(43) Pub. Date: Sep. 15, 2022

(54) EARLY WARNING METHOD AND EARLY WARNING APPARATUS FOR SERVICE FLOW, STORAGE MEDIUM, AND COMPUTER EQUIPMENT

(71) Applicant: CHANGXIN MEMORY TECHNOLOGIES, INC., Hefei City (CN)

(72) Inventor: Hui ZHANG, Hefei City (CN)

(21) Appl. No.: 17/647,181

(22) Filed: Jan. 6, 2022

Related U.S. Application Data
(63) Continuation of application No. PCT/CN2021/109436, filed on Jul. 30, 2021.

(30) Foreign Application Priority Data
Mar. 12, 2021 (CN) 202110270704.0

(51) Int. Cl. H04L 43/062; H04L 43/0876; H04L 43/045

(52) U.S. Cl. CPC H04L 43/062; H04L 43/0876; H04L 43/045

(57) ABSTRACT

The present disclosure relates to an early warning method and apparatus for a service flow, a storage medium, and a computer equipment. The method includes: acquiring database audit data; obtaining at least one related service table associated with each service unit based on the database audit data; obtaining a service flow graph based on the database audit data and the at least one related service table; acquiring an execute statement, and analyzing the execute statement; and if the execute statement has an error, giving an early warning through the service flow graph.

### CROSS-REFERENCE TO RELATED APPLICATIONS

This is a continuation of International Application No. PCT/CN2021/109436, filed on Jul. 30, 2021, which claims the priority to Chinese Patent Application 202110270704.0, titled “EARLY WARNING METHOD AND EARLY WARNING APPARATUS FOR SERVICE FLOW, STORAGE MEDIUM, AND COMPUTER EQUIPMENT” and filed on Mar. 12, 2021. The entire contents of International Application No. PCT/CN2021/109436 and Chinese Patent Application 202110270704.0 are incorporated herein by reference.

### TECHNICAL FIELD

The present disclosure relates but not only to, an early warning method and an early warning apparatus for a service flow, a storage medium, and a computer equipment.

### BACKGROUND

Service system logics of enterprises are increasingly complex. However, the traditional technology cannot clearly express the service flow, so that service personnel and developers cannot grasp the logical relationship of service data well, and the processing speed of service problems is slow.

### SUMMARY

On the one hand, the present disclosure provides an early warning method for a service flow, including:

acquiring database audit data;

obtaining at least one related service table associated with each service unit based on the database audit data;

obtaining a service flow graph based on the database audit data and the at least one related service table;

acquiring an execute statement, and analyzing the execute statement; and

if the execute statement has an error, giving an early warning through the service flow graph.

An early warning apparatus for a service flow, including a memory and a processor, wherein the memory stores a computer program executable on the processor, and when executing the computer program, the processor implements:

acquiring database audit data, and obtaining at least one related service table associated with each service unit based on the database audit data;

obtaining a service flow graph based on the database audit data and the at least one related service table; and

giving an early warning when the execute statement has an error.

A storage medium, storing a computer program therein, wherein when the computer program is executed by a processor, any one of the above-mentioned methods is implemented.

### BRIEF DESCRIPTION OF THE DRAWINGS

In order to explain technical solutions in embodiments of the present disclosure or in the prior art more clearly, the accompanying drawings to be used for describing the embodiments of the present disclosure or the prior art will be introduced simply. Apparently, the accompanying drawings to be described below are merely some embodiments of the present disclosure. A person of ordinary skill in the art may obtain other drawings according to these drawings without paying any creative effort.

FIG. 1 is a flowchart of an early warning method for a service flow provided in an embodiment;

FIG. 2 is an application scenario diagram of an early warning method and an early warning apparatus for a service flow provided in an embodiment;

FIG. 3 is a schematic diagram of a service flow graph provided in an embodiment;

FIG. 4 is a flowchart of an early warning method for a service flow provided in another embodiment;

FIG. 5 is a flowchart of an early warning method for a service flow provided in still another embodiment;

FIG. 6 is a schematic diagram of an initial data dictionary provided in an embodiment;

FIG. 7 is a flowchart of specific steps of step S134 provided in an embodiment;

FIG. 8 is a schematic diagram of a calculation process of a minimum spanning tree algorithm provided in an embodiment;

FIG. 9 is a flowchart of specific steps of step S143 provided in an embodiment;

FIG. 10 is a structural block diagram of an early warning apparatus for a service flow provided in an embodiment.

FIG. 11 is a block diagram of an early warning apparatus for a service flow in an embodiment.

### REFERENCE NUMERALS

21—front-end application; 22—application database; 23—early warning method and apparatus for a service flow; 24—front end; 31—service unit; 32—processed information; 33—error log; 60—initial data dictionary; 61—service name; 62—service table identifier; 63—table annotation; 100—early warning apparatus for a service flow; 110—data acquisition device; 120—service flow graph generating apparatus; 130—early warning apparatus; 1100—early warning apparatus for a service; 1101—processor; 1102—memory.

### DETAILED DESCRIPTION

In order to facilitate the understanding of the present disclosure, the present disclosure will be described more comprehensively below with reference to the relevant accompanying drawings. Preferred embodiments of the present disclosure are given in the drawings. However, the present disclosure may be implemented in many different forms, and is not limited to the embodiments described herein. Rather, these embodiments are provided so that the disclosure of the present disclosure is more thorough and comprehensive.

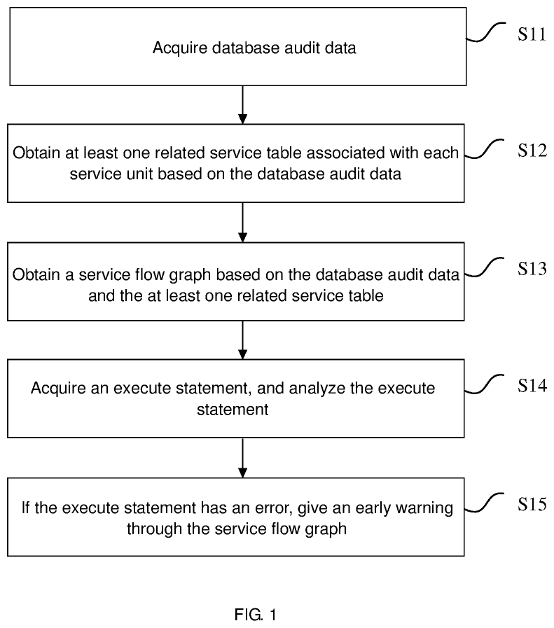

FIG. 1 is a flowchart of an early warning method for a service flow provided in an embodiment. As shown in FIG. 1, the early warning method for a service flow includes:

Step S11, database audit data is acquired.

Specifically, the database audit data is data obtained under a database audit function, and the database audit data can be acquired by enabling the database audit function. The code of a core system is equivalent to a black box for the operator, so the operator cannot know the specific content of the code. Through the database audit function, operations of adding data, deleting data, changing data or searching data in a database can be monitored in real time to obtain the database audit data.

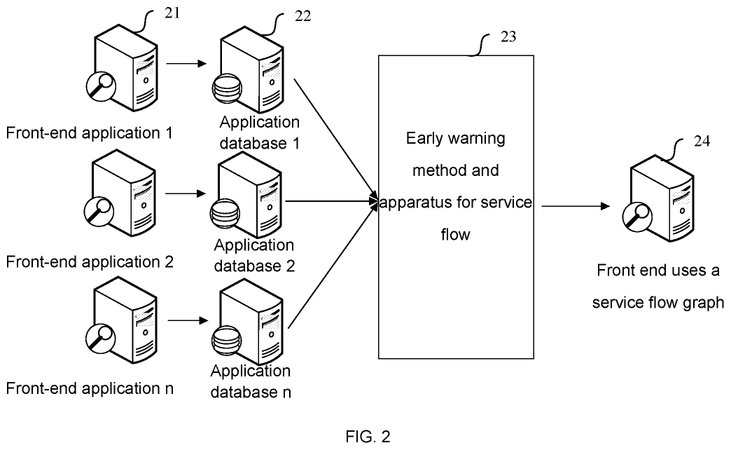

For example only, referring to FIG. 2, the database of front-end application 1 is application database 1, the database of front-end application 2 is application database 2 . . . the database of front-end application n is application database n (n is a positive integer, the number of application databases 22 is the same as the number of front-end applications 21 and the both correspond one to one). The early warning method and apparatus for a service flow 23 provided in the present disclosure can acquire database audit data from application database 1 to application database n by enabling the database audit function, generate a service flow graph by analyzing the database audit data of the application databases 22, and thus present the service flow graph to a front end 24 for the front end 24 to use.

Step S12, at least one related service table associated with each service unit is obtained based on the database audit data.

Specifically, the service units may be configured according to the application scenario of the service flow graph. For example, the service units may be respectively a contract, an order, a delivery, an invoice, etc. The at least one related service table is associated with the corresponding service units. When the operator operates a service interface, an operation trajectory is generated in the database, these operations are monitored by the audit function to generate database audit data, and at least one related service table associated with each service unit can be obtained based on the database audit data.

Step S13, a service flow graph is obtained based on the database audit data and the at least one related service table.

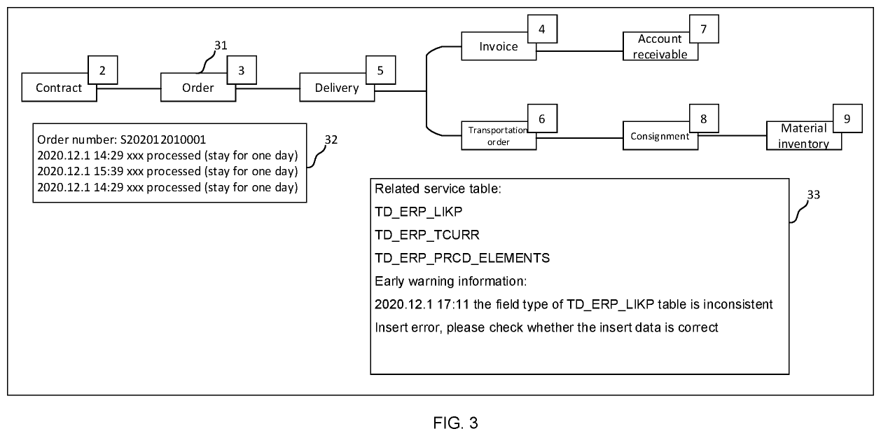

Specifically, the service flow graph may include all service units related to a service and a flow relationship between the service units. FIG. 3 provides a schematic diagram of a service flow graph in an embodiment. As shown in FIG. 3, the service flow graph is a sales service flow graph. The service flow graph includes all service units 31 related to a sales service. The service units 31 are respectively a contract, an order, a delivery, an invoice, an account receivable, a transportation order, a consignment, and a material inventory. The service flow graph further includes a flow relationship between the service units 31, for example, the contract flows to the order, the order flows to the delivery, the delivery flows to the invoice and the transportation order, etc. All the service units 31 and the relationship between the service units 31 in the service flow graph can be obtained based on the database audit data and the at least one related service table, thus obtaining the service flow graph.

It should be noted that FIG. 3 is only an example of the service flow graph, the sales service flow graph generated in the present disclosure is not limited to the service units and the relationship between the service units in in FIG. 3, the service flow graph is not limited to the sales service flow graph, and a procurement service flow graph and the like may also be generated.

Step S14, acquire an execute statement, and analyze the execute statement.

Step S15, if the execute statement has an error, an early warning is given through the service flow graph.

In the above-mentioned early warning method for a service flow, a service flow graph can be automatically generated, the service flow graph can show all service units in a service and a relationship between the service units and clearly express a service flow, and an early warning can be given to the wrong execute statement in time through the service flow graph, thereby enhancing service grasping of service and technical personnel and improving the processing speed of service problems.

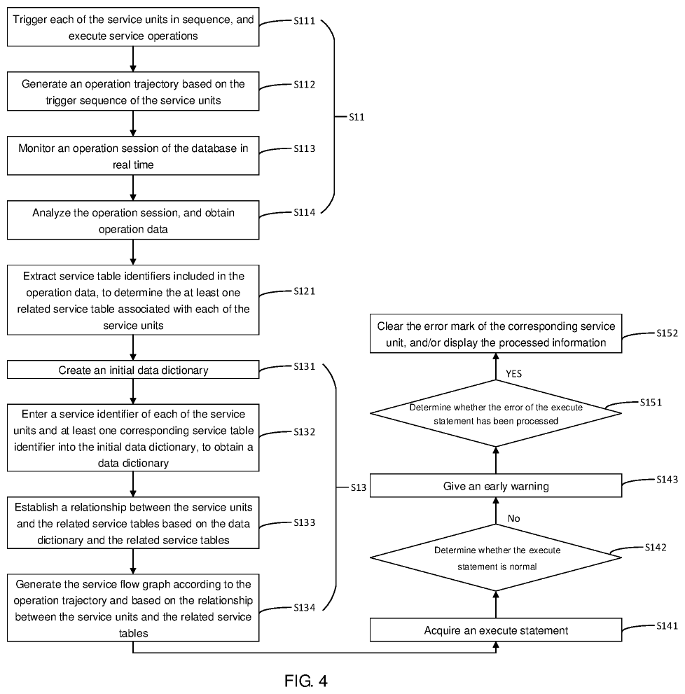

In an embodiment, the database audit data includes an operation trajectory and operation data, and the service operation includes at least one of adding data, deleting data, altering data, or searching data. In this embodiment, referring to FIG. 4, step S11, acquiring database audit data includes steps S111 to S114.

Step S111, the service units are triggered in sequence, and service operations are executed.

Specifically, the operator may trigger each of the service units in sequence through an operation interface, and the service system triggers the corresponding service units and executes the service operations after receiving the trigger information. It may also be configured that the service system automatically triggers the service units and execute corresponding service operations.

Step S112, an operation trajectory is generated based on the trigger sequence of the service units.

Specifically, the change of the database can be monitored by enabling the database audit function, so as to obtain the trigger sequence of the service units. The operation trajectory in this embodiment may include the trigger sequence of the service units, for example, operating the contract first, then operating the order, etc.

Step S113, an operation session of the database is monitored in real time.

Specifically, the change of the database can be monitored by enabling the database audit function, so as to monitor the operation session of the database. The operation session may include specific operation content of a service unit, for example, changing unit price amount data of the product in the contract.

Step S114, the operation session is analyzed to obtain operation data.

Specifically, the operation data may include specific operation content of the service unit. Since the operation session and the operation data are different in format, the operation session needs to be analyzed, and obtain the operation data in a format that can be identified in step S12, which facilitates the extracting of the service data table included in the operation data.

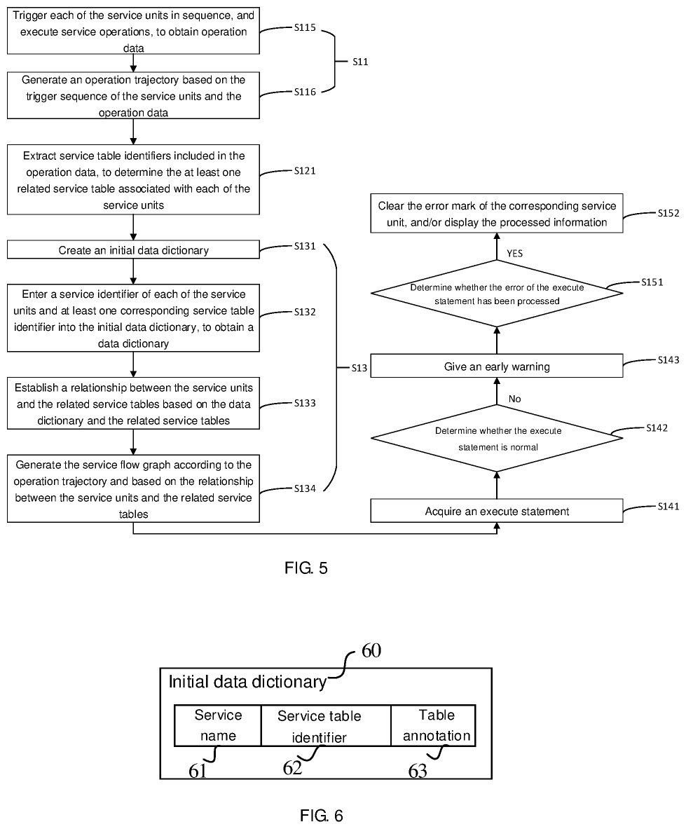

In another embodiment, the database audit data includes an operation trajectory. Referring to FIG. 5, step S11, acquiring database audit data includes steps S115 to S116.

Step S115, the service units are triggered in sequence, and service operations are executed to obtain operation data.

Specifically, the operator may trigger each of the service units in sequence through an operation interface, and the service system triggers the corresponding service units and executes the service operations after receiving the trigger information. It may also be configured that the service system automatically triggers the service units and execute corresponding service operations. The service operation includes at least one of adding data, deleting data, changing data, or searching data. The operation data may include specific operation content of a service unit. The change of the database can be monitored by enabling the database audit function, so that the operation data can be obtained after the service system executes the service operation.

Step S116, the operation trajectory including the operation data is generated based on the trigger sequence of the service units and the operation data.

Specifically, the operation trajectory in this embodiment not only includes the trigger sequence of the service units, but also includes specific operation content of each service unit. The operation trajectory can be generated based on the trigger sequence of the service units and the operation data.

In one embodiment, referring to FIG. 4 or 5, step S12 of obtaining at least one related service table associated with each service unit based on the database audit data includes step S121.

Step S121, service table identifiers included in the operation data are extracted to determine the at least one related service table associated with each service unit.

Specifically, in the embodiment shown in FIG. 4, the service table identifiers included in the operation data in step S114 are extracted to determine the at least one related service table associated with each service unit. In the embodiment shown in FIG. 5, the operation trajectory is generated based on the trigger sequence of the service units and the operation data, and the operation trajectory includes information of the operation data, so the service table identifiers included in the operation data can be extracted to determine the at least one related service table associated with each service unit.

Exemplarily, when the operator clicks on a front-end service related interface (for example, Sales), the database generates a session and operation data. The operation data may include, for example, a query statement, an insert statement, a delete statement, and an alter statement. The query statement is Select xxx xxx From TD_ERP_LIPS aINNER JOIN TD_ERP_LIKP b ON a.VBELN=b.VBELN. The insert statement is Insert into TD_ERP_LIKP(XXX,XXX,XXX) Values(xxx,xxx,xx). The delete statement is Delete from TD_ERP_LIKP where xxx=xxx. The alter statement is UPDATE TD_ERP_LIKP SET XXX=XXX where xxx=xxx. According to the statement standard specification, the service table identifiers “TD_ERP_LIPS” and “TD_ERP_LIK” in the operation statements are extracted. The at least one related service table associated with each service unit is determined according to the extracted service table identifiers, each service unit is associated with one or more related service tables, and there is a corresponding relationship between the service units and the related service tables.

In one embodiment, referring to FIG. 4 or 5, step S13 of obtaining a service flow graph based on the database audit data and the at least one related service table includes steps S131 to S134.

Step S131, an initial data dictionary is created.

Specifically, the initial data dictionary is an initial model of a data dictionary, which includes all parameters of the data dictionary, but does not include data of the parameters. FIG. 6 is a schematic diagram of an initial data dictionary 60 provided in an embodiment. As shown in FIG. 6, the parameters of the data dictionary may include a service name 61 and a service table identifier 62, and may further include a table annotation 63 and the like. The initial model of the data dictionary in the present disclosure is not limited to the embodiment shown in FIG. 6.

Step S132: a service identifier of each of the service units and at least one corresponding service table identifier are entered into the initial data dictionary to obtain a data dictionary.

Specifically, the service identifier of each service unit is the name of the service unit, and the service identifier of the service unit may be specific parameter data of the service name 61 in the embodiment of FIG. 6. For example, the service identifiers may include a contract, an order, a delivery, an invoice, an account receivable, etc. The service table identifier may be specific parameter data of the service table identifier 62 in the embodiment of FIG. 6. For example, the service table identifier may include TD_ERP_LIK and the like. A service identifier of a service unit in the data dictionary may correspond to a single service table identifier or a plurality of service table identifiers. The service identifier of each of the service units and the at least one corresponding service table identifier are entered into the initial data dictionary 60 to obtain a data dictionary.

Step S133, a relationship between the service units and the related service tables is established based on the data dictionary and the related service tables.

Specifically, the data dictionary includes information of all service identifiers of service units and service table identifiers corresponding to the service identifiers, and each related service table includes the relationship between the service units and the service table (that is, the related service table is associated with the corresponding service units), so that the relationship between each service unit and the at least one related service table can be established based on the related service tables of the data dictionary.

Step S134, generate the service flow graph according to the operation trajectory and based on the relationship between the service units and the related service tables.

Specifically, the operation trajectories in the embodiments shown in FIGS. 4 and 5 each include the trigger sequence of the service units, and generate the service flow graph based on the trigger sequence of the service units (including error information of all service units and the trigger sequence of the service units) and the relationship between the service units and the related service tables.

In one embodiment, in step S134 of generating the service flow graph according to the operation trajectory and based on the relationship between the service units and the related service tables, generate the service flow graph using a minimum spanning tree algorithm. In other embodiments, they may also generate the service flow graph by other algorithms well known to those skilled in the art.

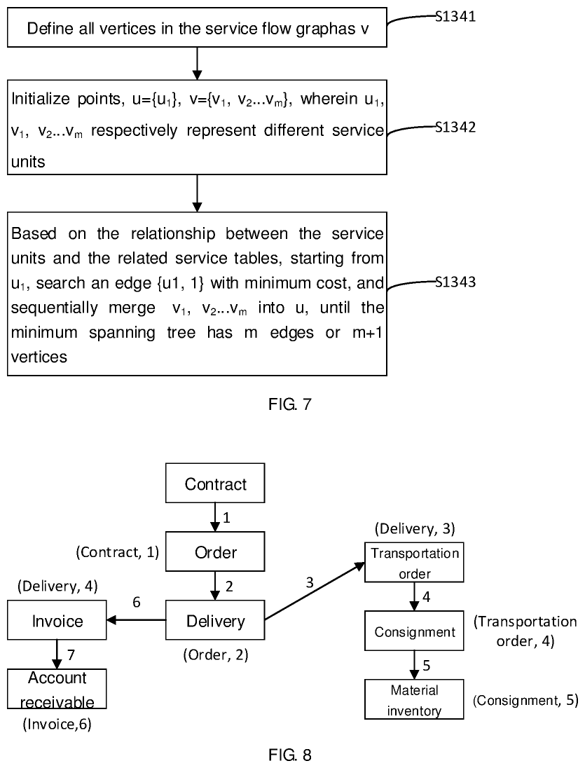

In an embodiment, as shown in FIG. 7, generating the service flow graph using a minimum spanning tree algorithm includes steps S1341 to S1343.

Step S1341, all vertices in the service flow graph are defined as v.

Step S1342, points are initialized, u={u₁}, v={v₁, v₂ . . . vₘ}, wherein u₁, v₁, v₂ . . . vₘ respectively represent different service units.

Step S1343, based on the relationship between the service units and the related service tables, starting from u₁, an edge {u₁, 1} with minimum cost is searched, and v₁, v₂ . . . vₘ are sequentially merged into u, until the minimum spanning tree has m edges or m+1 vertices. m is a positive integer.

Exemplarily, u₁ is a contract, v₁ is an order, v₂ is a delivery, v₃ is a transportation order, v₄ is an invoice, v₅ is a consignment, v₆ is a material inventory, and v₇ is an account receivable.

Specifically, referring to FIG. 8, all vertices in the service flow graph are defined as v. Then, points are initialized u={contract}, v={order, delivery, transportation order, invoice, consignment, material inventory, account receivable}. Next, starting from {contract}, an edge {contract, 1} with minimum cost is searched, and {order} is merged into u. The previous steps are repeated, until the minimum spanning tree has m edges or m+1 vertices.

In an embodiment, referring to FIG. 4 or 5, the early warning method for a service flow further includes steps S141 to S143.

Step S141, an execute statement is acquired.

Step S142, whether the execute statement is normal is determined.

Step S143, an early warning is given.

Specifically, the change of the database can be monitored by enabling the database audit function to acquire an execute statement. Analyze the execute statement to extract at least one service table identifier and data to be executed that are included in the execute statement; whether the acquired execute statement is normal is determined by detecting whether the data to be executed match the at least one related service table corresponding to the at least one service table identifier, for example, whether the field type of a table inserted in the execute statement meets the requirements is determined. If the data to be executed do not match the at least one related service table corresponding to the at least one service table identifier, it is determined that the execute statement has an error; and if the execute statement has an error, step S143 is executed for early warning, and the early warning may be performed through the service flow graph.

In one embodiment, in step S142, the execute statement may be analyzed using a database execute plan to detect whether the execute statement is normal. The database execute plan only analyzes the statement and does not actually execute the statement to generate data, and will not affect the use of the formal environment.

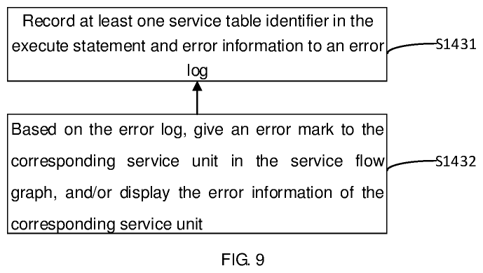

In one embodiment, as shown in FIG. 9, step S143 of giving an early warning includes steps S1431 and S1432.

Step S1431, the at least one service table identifier in the execute statement and error information are recorded to an error log.

Step S1432, based on the error log, an error mark is given to the corresponding service unit in the service flow graph, and/or the error information of the corresponding service unit is displayed.

Specifically, if the execute statement has an error, the at least one service table identifier therein and error information are analyzed and recorded in the error log, for example, the error log 33 shown in FIG. 3. A service early warning apparatus may be configured to extract the error log for service early warning. In an example, the service early warning apparatus may mark the error of the corresponding service unit in the service flow graph based on the error log. For example, the service early warning apparatus may set an error symbol near the corresponding service unit in the service flow graph, or set the corresponding service unit in the service flow graph to a preset color, so as to give an early warning. In other examples, the service early warning apparatus may display the error information of the corresponding service unit in the service flow graph based on the error log, so as to give an early warning.

In this embodiment, whether the execute statement is normal is detected, and if an error occurs, an early warning is given to the corresponding service unit. That is, tracking the status of service documents can quickly locate which service units are affected, so that the operator and service personnel can intuitively understand the range of data involved in the service units, which further improves their processing speed of service problems.

In an embodiment, referring to FIG. 4 or 5, the early warning method for a service flow further includes steps S151 and S152.

Step S151, whether the error of the execute statement has been processed is determined.

Step S152, the error mark of the corresponding service unit is cleared, and/or the processed information is displayed.

Specifically, whether the error of the execute statement has been processed is determined, for example, the execute statement may be altered, and whether the altered execute statement is normal may be detected again using the database execute plan. If the altered execute statement is normal, it is determined that the error of the execute statement has been processed; if the altered execute statement still has an error, it is determined that the error of the execute statement has not been processed. If the error of the execute statement has been processed, step S152 is executed. If an error mark is given to the corresponding service unit in the service flow graph based on the error log in step S1432 when the execute statement has an error, the error mark of the corresponding service unit is cleared and/or the processed information is displayed in step S152; if the error information of the corresponding service unit is displayed based on the error log in step S1432 when the execute statement has an error, the processed information may be displayed in step S152. For example, referring to FIG. 3, the processed information 32 may include processing time, processing person, processing time, etc.

Exemplarily, referring to FIG. 3, after generating the service flow graph, an execute statement is acquired and whether the execute statement is normal is determined. The related service tables of the consignment in the service unit 31 include TD_ERP_LIKP, TD_ERP_TCURR and TD_ERP_PRCD_ELEMENTS. If the execute statement has an error that the field type of the TD_ERP_LIKP table is inconsistent, the execute statement is related to the consignment in the service unit 31 and the execute statement has an error, the consignment is marked in red to give an early warning and the related service table information of the consignment is displayed. After the error of the execute statement has been processed, the consignment can be re-marked in a normal color, and the processed information 31 is displayed. For example, according to the processing progress of the consignment, the consignment that has not been processed may be marked in gray, the processed consignment may be marked in green, the consignment to be processed may be marked in yellow, etc. For example, the processed information may include order number, processing time (for example, “2020.12.1 14:29” in FIG. 3), processing person (for example, “xxx” in FIG. 3), processing progress (for example, “processed” in FIG. 3), processing duration (for example, “stay for one day” in FIG. 3), etc.

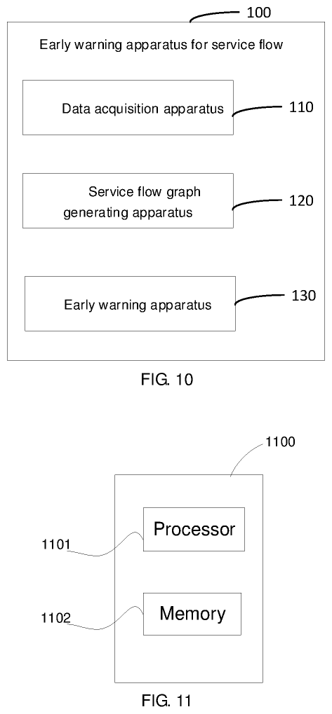

The present disclosure further provides an early warning apparatus for a service flow. As shown in FIG. 10, the early warning apparatus 100 for a service flow includes a data acquisition apparatus 110, a service flow graph generating apparatus 120, and an early warning apparatus 130. The data acquisition apparatus 110 is configured to acquire database audit data, and obtain at least one related service table associated with each service unit based on the database audit data. The service flow graph generating apparatus 120 is configured to obtain a service flow graph based on the database audit data and the at least one related service table. The early warning apparatus 130 is configured to acquire an execute statement, analyze the execute statement, and give an early warning through the service flow graph if the execute statement has an error.

In an embodiment, the database audit data includes an operation trajectory and operation data, and the operation includes at least one of adding data, deleting data, altering data, or searching data; when the data acquisition apparatus 110 acquires the database audit data, it specifically executes: triggering each of the service units in sequence, and executing service operations; generating the operation trajectory based on the trigger sequence of the service units; monitoring an operation session of a database in real time; and analyzing the operation session, and obtaining the operation data.

In another embodiment, the database audit data includes an operation trajectory; when the data acquisition apparatus 110 acquires the database audit data, it specifically executes: triggering each of the service units in sequence, and executing service operations to obtain operation data, the operation including at least one of adding data, deleting data, altering data, or searching data; and generating the operation trajectory based on the trigger sequence of the service units and the operation data.

In one embodiment, when the data acquisition apparatus 110 obtains at least one related service table associated with each service unit based on the database audit data, it specifically executes: extracting service table identifiers included in the operation data to determine the at least one related service table associated with each service unit.

In one embodiment, when the service flow graph generating apparatus 120 obtains a service flow graph based on the database audit data and the at least one related service table, it specifically executes: creating an initial data dictionary; entering a service identifier of each of the service units and at least one corresponding service table identifier into the initial data dictionary to obtain a data dictionary; establishing a relationship between the service units and the related service tables based on the data dictionary and the related service tables; generating the service flow graph according to the operation trajectory and based on the relationship between the service units and the related service tables.

In an embodiment, the service flow graph generating apparatus 120 generates the service flow graph using a minimum spanning tree algorithm.

In one embodiment, when the service flow graph generating apparatus 120 generates the service flow graph using a minimum spanning tree algorithm, it specifically executes: defining all vertices in the service flow graph as v; initializing points, u={u₁}, v={v₁, v₂ . . . vₘ}, wherein u₁, v₁, v₂ . . . vₘ respectively represent different service units; and based on the relationship between the service units and the related service tables, starting from u₁, searching an edge {u₁, 1} with minimum cost, and sequentially merging v₁, v₂ . . . vₘ into u, until the minimum spanning tree has m edges or m+1 vertices, wherein m is a positive integer.

In one embodiment, u₁ is a contract, v₁ is an order, v₂ is a delivery, v₃ is a transportation order, v₄ is an invoice, v₅ is a consignment, v₆ is a material inventory, and v₇ is an account receivable.

In an embodiment, the early warning apparatus 100 for a service flow further includes an early warning apparatus (not shown in the figure). The early warning apparatus includes an execute statement acquisition module and an analysis module. The execute statement acquisition module is configured to acquire an execute statement. The analysis module is configured to determine whether the execute statement is normal. The analysis module is configured to give an early warning when the execute statement has an error.

In one embodiment, the analysis module uses a database execute plan to detect whether the execute statement is normal.

In one embodiment, when the analysis module gives an early warning, it specifically executes: recording at least one service table identifier in the execute statement and error information to an error log; and based on the error log, giving an error mark to the corresponding service unit in the service flow graph, and/or displaying the error information of the corresponding service unit.

In an embodiment, the analysis module is further configured to determine whether the error of the execute statement has been processed. The analysis module is further configured to clear the error mark of the corresponding service unit and/or display the processed information when the error of the execute statement has been processed.

For specific limitations on the early warning apparatus 100 for a service flow, reference may be made to the above limitations on the early warning method for a service flow, and details are not described herein again. The various modules in the above-mentioned early warning apparatus 100 for a service flow may be implemented in whole or in part by software, hardware and a combination thereof. The above modules may be embedded in or independent of a processor in a computer device in the form of hardware, or stored in a memory of the computer device in the form of software, so that the processor invokes the operations corresponding to the modules.

In one embodiment, a computer equipment is further provided, including a memory and a processor, the memory storing a computer program therein, wherein when the processor executes the computer program, each of the above-mentioned method embodiments is implemented.

FIG. 11 is a block diagram of an early warning apparatus for a service flow in an embodiment.

In one embodiment, referring to FIG. 11, an early warning apparatus for a service flow 1100 is further provided, including a memory 1102 and a processor 1101, the memory 1102 storing a computer program therein, wherein when the processor 1101 executes the computer program, each of the above-mentioned method embodiments is implemented.

In an exemplary embodiment, a non-transitory computer-readable storage medium including instructions is provided. Referring to FIG. 11, for example, the non-transitory computer-readable storage medium may be the memory 1102 including instructions. The foregoing instructions may be executed by the processor 1101 of the early warning apparatus for a service flow 1100 to complete the foregoing method. For example, the non-transitory computer-readable storage medium may be a ROM, a RAM, a CD-ROM, a magnetic tape, a floppy disk, an optical data storage device, or the like.

In one embodiment, a computer-readable storage medium is provided, storing a computer program therein, wherein when the computer program is executed by a processor, each of the above-mentioned method embodiments is implemented.

A person of ordinary skill in the art can understand that all or part of the processes in the methods of the foregoing embodiments can be implemented by a computer program instructing relevant hardware. The computer program may be stored in a non-volatile computer-readable storage medium. The computer program, when executed, may include the processes of the embodiments of the above methods. Any reference to the memory, storage, database or other media used in the embodiments provided by the present disclosure may include at least one of non-volatile and volatile memories. The non-volatile memory may include a Read-Only Memory (ROM), a magnetic tape, a floppy disk, a flash memory, or an optical memory. The volatile memory may include a Random Access Memory (RAM) or an external cache memory.

As an illustration and not a limitation, the RAM can be in various forms, such as a Static Random Access Memory (SRAM) or a Dynamic Random Access Memory (DRAM).

Persons skilled in the art should understand that the embodiments of the present disclosure may be provided as a method, an apparatus (device), or a computer program product. Therefore, the present disclosure may use a form of hardware only examples, software only examples, or examples with a combination of software and hardware. Moreover, the present disclosure may be in a form of a computer program product that is implemented on one or more computer-usable storage media that include computer-usable program code. In addition, as is well known to persons of ordinary skill in the art, the communication media usually contain computer-readable instructions, data structures, program modules, or other data in modulated data signals such as carrier waves or other transmission mechanisms, and may include any information transfer medium.

The present disclosure is described with reference to the flowcharts and/or block diagrams of the method, the apparatus (device), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, such that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, such that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, such that a series of operations and steps are performed on the computer or the another programmable device, thereby generating computer-implemented processing. Therefore, the instructions executed on the computer or the another programmable device provide steps for implementing a function specified in one or more processes in the flowcharts and/or in one or more blocks in the block diagrams.

The technical features of the above embodiments may be combined arbitrarily. For the purpose of simplicity in description, all the possible combinations of the technical features in the above embodiments are not described. However, as long as the combinations of these technical features do not have contradictions, they shall fall within the scope of the specification.

The above-mentioned embodiments only describe several implementations of the present disclosure, and their descriptions are specific and detailed, but cannot therefore be understood as limitations to the patent scope of the present disclosure. It should be noted that a person of ordinary skill in the art may further make variations and improvements without departing from the conception of the present disclosure, and these all fall within the protection scope of the present disclosure. Therefore, the patent protection scope of the present disclosure should be subject to the appended claims.

1. An early warning method for a service flow, comprising:
acquiring database audit data;
obtaining at least one related service table associated with each service unit based on the database audit data;
obtaining a service flow graph based on the database audit data and the at least one related service table;
acquiring an execute statement, and analyzing the execute statement; and
when the execute statement has an error, giving an early warning through the service flow graph.

2. The early warning method for a service flow according to claim 1, wherein the database audit data comprise an operation trajectory and operation data, and the operation comprises at least one of adding data, deleting data, altering data, or searching data; the acquiring database audit data comprises:
triggering each of the service units in sequence, and executing service operations;
generating the operation trajectory based on a trigger sequence of the service units;
monitoring an operation session of a database in real time; and
analyzing the operation session, and obtaining the operation data.

3. The early warning method for a service flow according to claim 1, wherein the database audit data comprise an operation trajectory; the acquiring database audit data comprises:
triggering each of the service units in sequence, and executing service operations, to obtain operation data, the service operations comprising at least one of adding data, deleting data, altering data, or searching data; and
generating the operation trajectory including the operation data based on a trigger sequence of the service units and the operation data.

4. The early warning method for a service flow according to claim 2, wherein the obtaining at least one related service table associated with each service unit based on the database audit data comprises:
extracting service table identifiers included in the operation data, to determine the at least one related service table associated with each of the service units.

5. The early warning method for a service flow according to claim 4, wherein the obtaining a service flow graph based on the database audit data and the at least one related service table comprises:
creating an initial data dictionary;
entering a service identifier of each of the service units and at least one corresponding service table identifier into the initial data dictionary, to obtain a data dictionary;
establishing a relationship between the service units and the related service tables based on the data dictionary and the related service tables; and
generating the service flow graph according to the operation trajectory and based on the relationship between the service units and the related service tables.

6. The early warning method for a service flow according to claim 5, wherein the generating the service flow graph according to the operation trajectory and based on the relationship between the service units and the related service tables comprises generating the service flow graph using a minimum spanning tree algorithm.

7. The early warning method for a service flow according to claim 6, wherein the generating the service flow graph using a minimum spanning tree algorithm comprises:
defining all vertices in the service flow graph as v;
initializing points, u={u₁}, the v={v₁, v₂ . . . vₘ}, wherein the u₁, the v₁, the v₂ . . . the vₘ respectively represent different service units; and
based on the relationship between the service units and the related service tables, starting from the u₁, searching an edge {u₁, 1} with minimum cost, and sequentially merging the v₁, the v₂ . . . the vₘ into the u, until a minimum spanning tree has m edges or m+1 vertices, wherein the m is a positive integer.

8. The early warning method for a service flow according to claim 7, wherein the u₁ is a contract, the v₁ is an order, the v₂ is a delivery, the v₃ is a transportation order, the v₄ is an invoice, the v₅ is a consignment, the v₆ is a material inventory, and the v₇ is an account receivable.

9. The early warning method for a service flow according to claim 1, wherein the acquiring an execute statement, and analyzing the execute statement comprises:
acquiring the execute statement;
analyzing the execute statement, to extract at least one service table identifier and data to be executed that are included in the execute statement; and
when the data to be executed do not match at least one related service table corresponding to the at least one service table identifier, determining that the execute statement has an error.

10. The early warning method for a service flow according to claim 9, wherein the analyzing the execute statement comprises analyzing the execute statement using a database execute plan.

11. The early warning method for a service flow according to claim 9, further comprising:
recording the at least one service table identifier in the execute statement and error information to an error log; and
the giving an early warning through the service flow graph comprises:
based on the error log, giving an error mark to corresponding service unit in the service flow graph, and/or displaying the error information of the corresponding service unit.

12. The early warning method for a service flow according to claim 11, further comprising:
determining whether the error of the execute statement has been processed; and
when the error has been processed, clearing the error mark of the corresponding service unit, and/or displaying a processed information.

13. An early warning apparatus for a service flow, comprising a memory and a processor, wherein the memory stores a computer program executable on the processor, and when executing the computer program, the processor implements:
acquiring database audit data, and obtaining at least one related service table associated with each service unit based on the database audit data;
obtaining a service flow graph based on the database audit data and the at least one related service table; and
acquiring an execute statement, analyzing the execute statement, and giving an early warning through the service flow graph when the execute statement has an error.

14. The early warning apparatus for a service flow according to claim 13, wherein when executing the computer program, the processor implements:
acquiring an execute statement; and
analyzing the execute statement, to extract at least one service table identifier and data to be executed that are included in the execute statement, and determining that the execute statement has an error when the data to be executed do not match at least one related service table corresponding to the at least one service table identifier.

15. A storage medium, storing a computer program therein, wherein when the computer program is executed by a processor, the method according to claim 1 is implemented.
